(19) United States
(12) Patent Application Publication
(10) Pub. No.: US 2015/0052326 A1
(43) Pub. Date: Feb. 19, 2015

(54) USER-CONTROLLED PAGING

(71) Applicant: International Business Machines Corporation, Armonk, NY (US)

(72) Inventors: Francis J. D. Bogsanyi, Ottawa (CA); Andrew R. Low, Stittsville (CA)

(73) Assignee: International Business Machines Corporation, Armonk, NY (US)

(21) Appl. No.: 13/969,665

(22) Filed: Aug. 19, 2013

(51) Int. Cl. G06F 3/06

(52) U.S. Cl. CPC G06F 3/0647; G06F 3/0605; G06F 3/067
USPC 711/165

(57) ABSTRACT

A request is received to load a first page into main memory with the main memory containing a plurality of page frames. It is determined that none of the plurality of page frames is an empty page frame. User input is referenced to determine a target memory resource consumer. A second page is selected which is loaded in a first page frame. The second page is associated with the target memory resource consumer. The second page is moved from the main memory to a secondary storage device. The first page is loaded into the first page frame.

### FIELD OF THE INVENTION

The present disclosure relates to memory management by computer operating systems, and more specifically to paging activity by computer operating systems.

### BACKGROUND

Virtual memory is a memory management technique which virtualizes the main storage available to a process in a computer system. The operating system manages the virtual address spaces and the assignment of real memory to virtual memory. Paging is an important aspect of virtual memory. Modern computer systems often use paging to expand the main memory capacity beyond the random access memory (RAM) installed.

### SUMMARY

Disclosed herein are embodiments of a method for controlling paging activity by a computer operating system. A request is received to load a first page into main memory with the main memory containing a plurality of page frames. It is determined that none of the plurality of page frames is an empty page frame. User input is referenced to determine a target memory resource consumer. A second page is selected which is loaded in a first page frame. The second page is associated with the target memory resource consumer. The second page is moved from the main memory to a secondary storage device. The first page is loaded into the first page frame.

Also disclosed herein are embodiments of a computer program product for controlling paging activity by a computer operating system. A computer readable storage medium has a program code embodied therewith. The program code is executable by a computer system to perform a method. A request is received to load a first page into main memory with the main memory containing a plurality of page frames. It is determined that none of the plurality of page frames is an empty page frame. User input is referenced to determine a target memory resource consumer. A second page is selected which is loaded in a first page frame. The second page is associated with the target memory resource consumer. The second page is moved from the main memory to a secondary storage device. The first page is loaded into the first page frame.

Also disclosed herein are embodiments of a computer system for controlling paging activity by a computer operating system. The computer system has one or more processors, one or more computer-readable memories, one or more computer-readable tangible storage devices, and program instructions stored on at least one of the one or more storage devices for execution by at least one of the one or more processors via at least one of the one or more memories. The program instructions for execution include program instructions to cause a computer to receive a request to load a first page into main memory with the main memory containing multiple page frames. The program instructions for execution further include program instructions to determine that there are no empty page frames in the main memory. The program instructions for execution further include program instructions to reference user input to determine a target memory resource consumer. The program instructions for execution further include program instructions to select a second page which is loaded in a first page frame. The second page is associated with the target memory resource consumer. The program instructions for execution further include program instructions to move the second page from the main memory to a secondary storage device. The program instructions for execution further include program instructions to load the first page into the first page frame.

### BRIEF DESCRIPTION OF THE DRAWINGS

FIG. 1 depicts a flow diagram of an example method for controlling paging activity by a computer operating system.

FIG. 2 depicts a flow diagram of an example method for controlling paging activity by a computer operating system.

FIG. 3 depicts a block diagram of an example computer system for controlling paging activity by a computer operating system.

### DETAILED DESCRIPTION

Paging occurs when a memory resource consumer, such as a program or process, attempts to access a page that is not mapped to main memory. This is known as a page fault. When a page fault occurs, the operating system will, in a manner invisible to the memory resource consumer, move the page from a secondary storage device to the main memory. If there is insufficient space in main memory to satisfy the memory resource consumer's request, a page must be moved from the main memory to a secondary storage device. The page may be moved to the same secondary storage device from which it originated or it may be moved to a separate secondary storage device. Before a memory resource consumer can use the page that was moved to the secondary storage device, the page must be loaded back in to main memory.

In modern computer systems, the operating system typically has a preprogrammed page replacement algorithm to decide which page to move to a secondary storage device in the event of a page fault with no empty page frames in main memory. Users do not have control over which pages will be paged out and which memory resource consumers will be affected. The secondary storage device is typically much slower than the main memory, so computer processes are slowed each time paging occurs when attempting to access memory. There is a trade-off between responsiveness of the computer system and increased memory resources which is acceptable to some users. However, sometimes when paging activity is high because of high memory usage, the responsiveness of the system can become very poor. The system can become unresponsive to user input. This can occur when a user opens too many programs at once, or attempts to open a file which is much larger than the user expected. When this happens, the user can wait for the period of high paging to end, power-cycle the machine, or attempt to close one or more applications to free up memory. Each of these options has drawbacks.

Embodiments of the current invention may provide for user control of paging activity performed by the operating system of a computer. The computer operating system may reference user input on a target memory resource consumer before selecting a page to be moved to a secondary storage device. This may allow the user to increase performance of the computer system by allowing the user to target pages corresponding to memory resource consumers which the user does not currently need. Additionally, in some embodiments the user may be able to free up memory by moving all pages associated with a memory resource consumer to a secondary storage device. There are many ways in which to provide a user with control of paging activity when there are no free page frames available in main memory.

In some embodiments, the user may be given control of paging activity in an interactive manner where the operating system asks the user for input when deciding what page to select for moving to a secondary storage device. For example, in some embodiments the operating system may provide the user with a dialog box containing a set of names of memory resource consumers which may be selected by the user as the target memory resource consumer. The memory resource consumers may be programs currently running or specific processes. Depending on the configuration, the operating system may incorporate the user's selection of a target memory resource consumer in several ways. In some embodiments, the operating system may select a page associated with the target memory resource consumer and move it to the secondary storage device. In other embodiments, the operating system may move all pages associated with a selected memory resource consumer to the secondary storage device and make the memory resource consumer inactive.

In some embodiments, the operating system may obtain information on page selection from a user-controlled configuration file which may be modified by the user in advance. The user-controlled configuration file can be any type of computer file which the operating system could access to obtain information. In some embodiments, the user-controlled file could contain a memory resource consumer targeting policy which the user could modify. The user-controlled file could contain a list of memory resource consumers that are listed in the order the user would want them selected as the target memory resource consumer. For example, the user may place their word processing program at the top of the list, followed by their email program. The operating system may first check to see if the word processing program has any pages in main memory. If the word processing program has any pages associated with it in main memory, the operating system may move one or more pages to a secondary storage device based on the policy. If the word processing program does not have any pages assigned to it in main memory, the operating system could repeat the process for the email program and continue down the list. In another example, the page selection policy could contain a list of memory resource consumers that the operating system should not select as the target memory resource consumer. These are only examples of memory resource consumer targeting policies and there are many others which would be considered by one of skill in the art to be within one or more embodiments of the present invention.

Memory management is usually handled deep within the kernel level of the operating system so changes to existing operating systems may need to be made at this deep level to implement embodiments of the invention. Space may be reserved in the main memory to do the processing required for embodiments of the invention.

In this detailed description, reference is made to the accompanying drawings, which illustrate example embodiments. It is to be understood that other embodiments may be utilized and structural changes may be made without departing from the scope of the invention. The terminology used herein is for the purpose of describing particular embodiments only and is not intended to be limiting of the invention. In accordance with features of the invention, a method, a system, and a computer program product are provided for user-controlled paging.

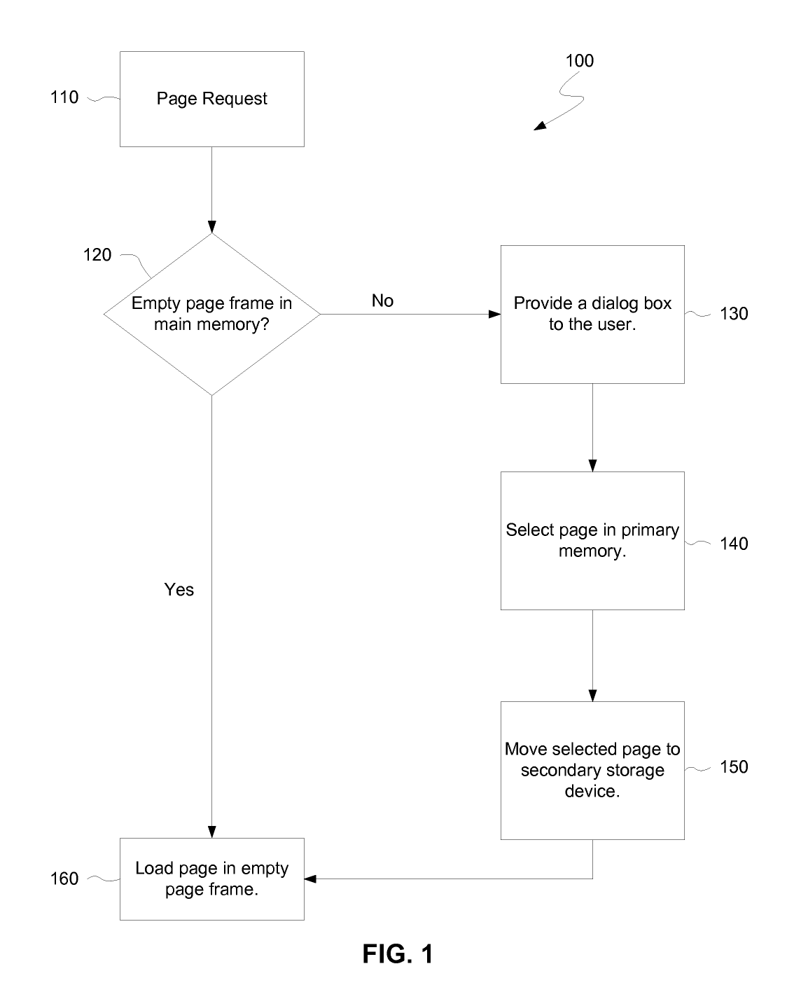

Referring now to FIG. 1, flow diagram 100 illustrates an example embodiment of a method for controlling paging activity by a computer operating system. At step 110, the operating system receives a request to load a first page into main memory. The request may be made in response to a page fault occurring after an attempt by a memory resource consumer to access a page which has not been mapped to main memory. At step 120, it is determined whether there is an empty page frame in main memory. If an empty page frame is available, the operating system may proceed to step 160 and load the page into the empty page frame in main memory. If it is determined that there are no empty page frames, the operating system may proceed to step 130.

At step 130, the operating system may provide a dialog box to the user which contains a set of names of candidate memory resource consumers which can be selected by the user as the target memory resource consumer. The candidate memory resource consumers may be all memory resource consumers which are currently running or may be a subset of the memory resource consumers, such as memory resource consumers which are not critical to performance of the computer system. At step 140, the operating system selects a page in main memory which is associated with the target memory resource consumer.

At step 150, the operating system moves the selected page from the main memory to a secondary storage device. This creates an empty page frame in main memory. Steps 140 and 150 may be repeated in some embodiments. For example, the memory resource consumer may be associated with a number of additional pages and the operating system may select the additional pages and move them from main memory to the secondary storage device. At step 160, the operating system loads the first page into an empty page frame.

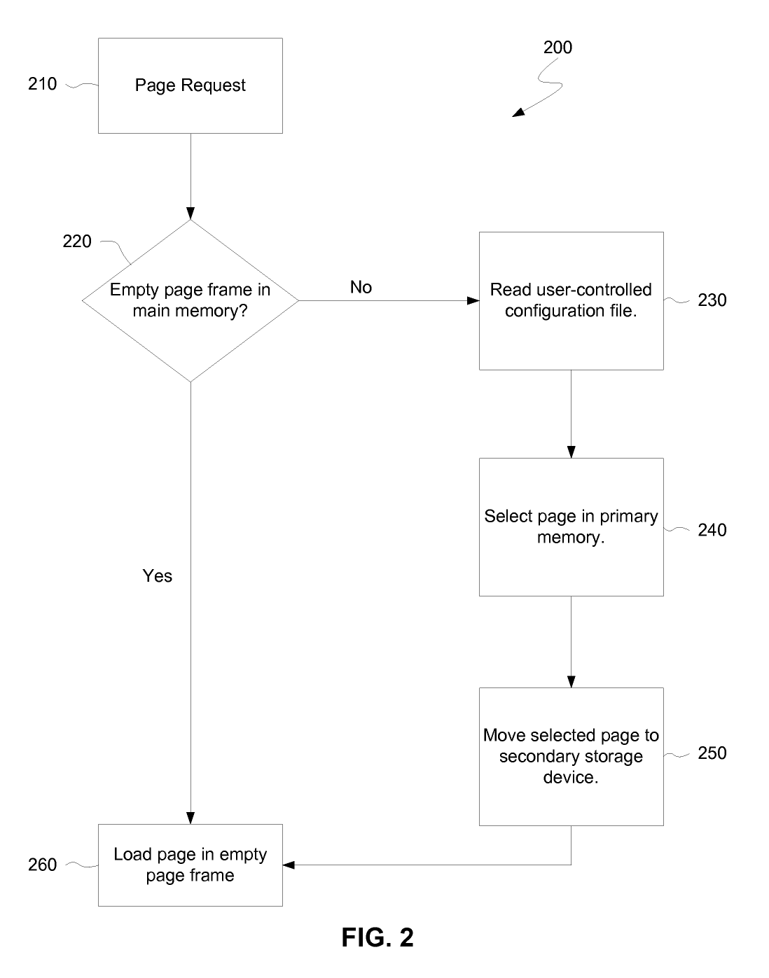

Referring now to FIG. 2, flow diagram 200 illustrates an example embodiment of a method for controlling paging activity by a computer operating system. At step 210, the operating system receives a request to load a first page into main memory. The request may be made in response to a page fault occurring after an attempt by a memory resource consumer to access a page which has not been mapped to main memory. At step 220, it is determined whether there is an empty page frame in main memory. If an empty page frame is available, the operating system may proceed to step 260 and load the page into the empty page frame in main memory. If there are no empty page frames, the operating system may proceed to step 230.

At step 230, the operating system may read a user-controlled configuration file. The user-controlled configuration file may contain a memory resource consumer targeting policy. In some embodiments, the targeting policy may contain an ordered list of programs with the order representing the user's preferred order to select the target memory resource consumer. In other embodiments, the targeting policy may contain a set of programs and the operating system would select a target memory resource consumer not contained within the set of programs At step 240, the operating system selects a page in main memory which is associated with the target memory resource consumer.

At step 250, the operating system moves the selected page from the main memory to a secondary storage device. This creates an empty page frame in main memory. At step 260, the operating system loads the first page into the empty page frame.

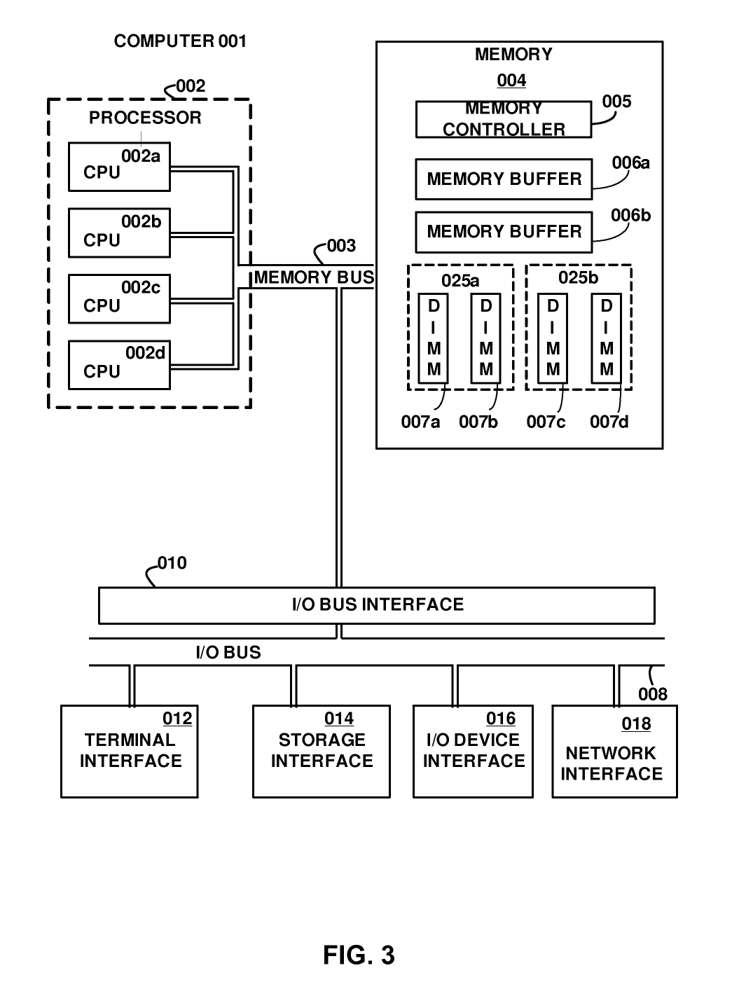

FIG. 3 depicts a high-level block diagram of an example system for implementing an embodiment. The mechanisms and apparatus of embodiments of the present invention apply equally to any appropriate computing system. The major components of the computer system 001 comprise one or more CPUs 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffer 006 and one or more memory devices 007. In the illustrated embodiment, the memory devices 007 may be dual in-line memory modules (DIMMs), which are a series of dynamic random-access memory (DRAM) chips 015a-015n (collectively referred to as 015) mounted on a printed circuit board and designed for use in personal computers, workstations, and servers. The use of DRAMs 015 in the illustration is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 6 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 3 is intended to depict the representative major components of an exemplary computer system 001. But individual components may have greater complexity than represented in FIG. 3, components other than or in addition to those shown in FIG. 3 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM 0015 may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

Embodiments described herein may be in the form of a system, a method, or a computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments are not intended to limit the present invention. Indeed, other alternative hardware and/or program environments may be used without departing from the scope of embodiments of the invention.

1-7. (canceled)

8. A computer program product for controlling paging activity by a computer operating system, the computer program product comprising a computer readable storage medium having program code embodied therewith, the program code executable by a computer system to perform a method comprising:
receiving a request to load a first page into main memory, the main memory containing multiple page frames;
determining that there are no empty page frames in the main memory;
referencing user input to determine a target memory resource consumer;
selecting a second page, the second page loaded in a first page frame, the second page associated with the target memory resource consumer;
moving the second page from the main memory to a secondary storage device; and
loading the first page into the first page frame.

9. The computer program product of claim 8, wherein the target memory resource consumer is associated with a number of additional pages, the method further comprising:
moving the number of additional pages from the main memory to the secondary storage device.

10. The computer program product of claim 8, wherein the referencing user input to determine a target memory resource consumer comprises:
providing a dialog box to a user, the dialog box containing a set of names of candidate memory resource consumers; and
receiving a selection from the user, the selection from the set of names, the selection representing the target memory resource consumer.

11. The computer program product of claim 10, wherein the candidate memory resource consumers are active processes.

12. The computer program product of claim 8, wherein the referencing user input to determine a target memory resource consumer comprises:
reading a user-controlled configuration file, the user-controlled configuration file containing a memory resource consumer targeting policy.

13. The computer program product of claim 12, wherein the memory resource consumer targeting policy contains an ordered list of programs, the list ordered to represent the user's preferred order to select the target memory resource consumer.

14. The computer program product of claim 12, wherein the memory resource consumer targeting policy contains a set of programs, and wherein the target memory resource consumer is not contained within the set of programs.

15. A computer system for controlling paging activity by a computer operating system, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions for execution comprising:
program instructions to cause a computer to receive a request to load a first page into main memory, the main memory containing multiple page frames;
program instructions to determine that there are no empty page frames in the main memory;
program instructions to reference user input to determine a target memory resource consumer;
program instructions to select a second page, the second page loaded in a first page frame, the second page associated with the target memory resource consumer;
program instructions to move the second page from the main memory to a secondary storage device; and
program instructions to load the first page into the first page frame.

16. The computer system of claim 15, wherein the target memory resource consumer is associated with a number of additional pages and the program instructions for execution further comprise:
program instructions to move the number of additional pages from the main memory to the secondary storage device.

17. The computer system of claim 16, wherein the program instructions to reference user input to determine a target memory resource consumer comprises:
program instructions to provide a dialog box to a user, the dialog box containing a set of names of candidate memory resource consumers; and
program instructions to receive a selection from the user, the selection from the set of names, the selection representing the target memory resource consumer.

18. The computer system of claim 16, wherein the program instructions to reference user input to determine a target memory resource consumer comprises:
program instructions to read a user-controlled configuration file, the user-controlled configuration file containing a memory resource consumer targeting policy.

19. The computer system of claim 18, wherein the memory resource consumer targeting policy contains an ordered list of programs, the list ordered to represent the user's preferred order to select the targeted memory resource consumer.

20. The computer system of claim 18, wherein the memory resource consumer targeting policy contains a set of programs, and wherein the target memory resource consumer is not contained within the set of programs.
